(19) United States
(12) Patent Application Publication
(10) Pub. No.: US 2024/0056399 A1
(43) Pub. Date: Feb. 15, 2024

(54) Transmission Control Method, Apparatus, and System

(71) Applicant: Huawei Technologies Co., Ltd., Shenzhen (CN)

(72) Inventors: Tao Wu, Nanjing (CN); Jian Yan, Nanjing (CN); Bingquan Wang, Nanjing (CN); Lei Han, Shenzhen (CN); Xiangyu Gong, Nanjing (CN); Huafeng Wen, Nanjing (CN)

(21) Appl. No.: 18/494,436

(22) Filed: Oct. 25, 2023

Related U.S. Application Data
(63) Continuation of application No. PCT/CN2021/139819, filed on Dec. 20, 2021.

(30) Foreign Application Priority Data
Apr. 26, 2021 (CN) 202110456076.5

(51) Int. Cl. H04L 47/30; H04L 47/62

(52) U.S. Cl. CPC H04L 47/30; H04L 47/6215

(57) ABSTRACT

A first communication apparatus obtains a sampling cycle. The sampling cycle is a time interval at which the first communication apparatus samples occupancy of a first buffer. The first buffer is used to store a data packet of a first priority. The first communication apparatus determines occupancy of the first buffer at a first sampling moment based on the sampling cycle. The first communication apparatus determines first duration based on the sampling cycle and the occupancy of the first buffer at the first sampling moment. The first duration is duration for which a second communication apparatus stops sending data to the first communication apparatus. The first communication apparatus sends first indication information to the second communication apparatus based on the first duration.

### CROSS-REFERENCE TO RELATED APPLICATIONS

This is a continuation of International Patent Application No. PCT/CN2021/139819 filed on Dec. 20, 2021, which claims priority to Chinese Patent Application No. 202110456076.5 filed on Apr. 26, 2021. The disclosures of the aforementioned applications are hereby incorporated by reference in their entireties.

### TECHNICAL FIELD

This disclosure relates to the field of communication, and in particular, to a transmission control method, an apparatus, and a system.

### BACKGROUND

The Institute of Electrical and Electronics Engineers (IEEE) 802.1 working group defines a Priority Flow Control (PFC) protocol to avoid packet loss in the Ethernet.

In an existing PFC protocol, as shown in FIG. 1, for a data packet of a specific priority, when a data packet processing capability of a receive end is inadequate, data packets are overstocked at the receive end. If space occupied by a data packet at the receive end reaches a threshold X_{off}, the receive end sends a PFC stop frame to a transmit end. After receiving the PFC stop frame, the transmit end stops data packet sending, and a last data packet sent by the transmit end before stopping data packet sending may arrive at the receive end. After a period of time, when space occupied by a data packet at the receive end decreases to a threshold Xₒₙ, the receive end sends a PFC transmit frame to the transmit end. After receiving the PFC transmit frame, the transmit end continues data packet sending. For example, as shown in FIG. 1, a first data packet sent by the transmit end may arrive at the receive end.

Currently, in one round-trip time from a moment when the receive end sends the PFC stop frame to a moment when the receive end receives the last data packet, a data packet received by the receive end is buffered in headroom (HDRM). A size of the HDRM is one bandwidth delay product (BDP). In addition, X_{off} and Xₒₙ also need a buffer whose size is at least one BDP, to ensure that the receive end continuously outputs data packets. Therefore, an existing PFC mechanism needs buffer space whose size is at least two BDPs.

To reduce a requirement on the size of the buffer space of the receive end, in another technology, values of X_{off}, and Xₒₙ are usually decreased, so that the values of X_{off}, and Xₒₙ are both less than one BDP. However, when X_{off}, is less than one BDP, the receive end may have no data packet to output between a moment at which the receive end sends the PFC transmit frame to the transmit end and a moment at which the receive end receives the first data packet sent by the transmit end.

### SUMMARY

Embodiments of this disclosure provide a transmission control method, an apparatus, and a system, to ensure that a receive end continuously outputs data packets.

To achieve the foregoing objective, the following technical solutions are used in embodiments of this disclosure.

A first aspect provides a transmission control method. A communication apparatus that performs the transmission control method may be a first communication apparatus, or may be a module, for example, a chip or a chip system, used in a first communication apparatus. The following provides descriptions by using an example in which an execution body is the first communication apparatus. The first communication apparatus obtains a sampling cycle. The sampling cycle is a time interval at which the first communication apparatus samples occupancy of a first buffer. The first buffer is used to store a data packet of a first priority. The first communication apparatus determines occupancy of the first buffer at a first sampling moment based on the sampling cycle. The first communication apparatus determines first duration based on the sampling cycle and the occupancy of the first buffer at the first sampling moment. The first duration is duration for which a second communication apparatus stops sending data to the first communication apparatus. The first communication apparatus sends first indication information to the second communication apparatus based on the first duration. The first indication information is used to control the duration for which the second communication apparatus stops sending data to the first communication apparatus.

In the transmission control method provided in this disclosure, the first communication apparatus periodically samples the occupancy of the first buffer, and determines the first duration based on the sampling cycle and the sampled occupancy of the first buffer. A value of the sampling cycle is small, so that based on this solution, the second communication apparatus can be controlled, at a finer granularity, to stop sending or send the data packet of the first priority.

With reference to the first aspect, in a possible implementation, the first duration is less than or equal to the sampling cycle. In this solution, the second communication apparatus is allowed to send the data packet of the first priority to the first communication apparatus in a first sampling cycle other than the first duration. Therefore, compared with an existing technical solution in which the first communication apparatus allows the second communication apparatus to send the data packet of the first priority only when the occupancy of the first buffer decreases to a threshold Xₒₙ, in the transmission control method provided in this disclosure, the second communication apparatus may be allowed in advance to send the data packet of the first priority, to ensure that a receive end continuously outputs data packets.

With reference to the first aspect, in a possible implementation, the first communication apparatus starts a timer whose timing duration is the first duration. When the timer expires, the first communication apparatus sends second indication information to the second communication apparatus. The second indication information indicates the second communication apparatus to send a data packet. In this solution, a moment at which the second communication apparatus sends a data packet to the first communication apparatus is controlled by using a timing function of the first communication apparatus, so that when the second communication apparatus does not have the timing function, the second communication apparatus can send the data packet to the first communication apparatus in time.

With reference to the first aspect, in a possible implementation, the first indication information is the first duration. In the transmission control method provided in this disclosure, the second communication apparatus may continue to send data after stopping data sending for the first duration based on the first indication information. In this solution, after the first communication apparatus sends the first indication information to the second communication apparatus, the second communication apparatus may not need to be triggered again, through signaling transmission, to resume data packet sending, so that signaling overheads can be reduced.

With reference to the first aspect, in a possible implementation, the first indication information is second duration. The second duration is maximum duration for which the second communication apparatus is allowed to stop data packet sending. In this solution, the first indication information is a time field in a PFC stop frame sent by the receive end to a transmit end if space occupied by a data packet at the receive end reaches a threshold X_{off}. Content of communication between the first communication apparatus and the second communication apparatus is the same as that in another technology, so that compatibility with an existing protocol may be improved.

With reference to the first aspect, in a possible implementation, that the first communication apparatus determines first duration based on the sampling cycle and the occupancy of the first buffer at the first sampling moment includes: the first communication apparatus determines the first duration based on the sampling cycle, the occupancy of the first buffer at the first sampling moment, and at least one of the following parameters: a data receiving rate of a port of the first communication apparatus, a rate at which the first communication apparatus receives the data packet of the first priority, cumulative time for which the second communication apparatus is allowed to send a data packet within 2T time before the first sampling moment, or a size of the first buffer. T indicates a unidirectional transmission delay of data transmission between the first communication apparatus and the second communication apparatus.

With reference to the first aspect, in a possible implementation, when the first sampling moment is a j^{th} sampling moment, and j is a positive integer, the first duration satisfies the following first formula:

tₛₜₒₚ(j)=t−((bₘₐₓᵢₘᵤₘ−b(j))/s−acc_2T(j))

tₛₜₒₚ(j) indicates first duration determined at the j^{th} sampling moment. t indicates the sampling cycle. bₘₐₓᵢₘᵤₘ indicates the size of the first buffer. s indicates the data receiving rate of the port of the first communication apparatus, or s indicates the rate at which the first communication apparatus receives the data packet of the first priority. b(j) indicates occupancy of the first buffer at the j^{th} sampling moment. acc_2T(j) indicates cumulative time for which the second communication apparatus is allowed to send a data packet within 2T time before the j^{th} sampling moment. The first communication apparatus periodically calculates, based on the occupancy of the first buffer, the first duration for which the second communication apparatus stops data sending. At the j^{th} sampling moment, if a value of b(j) is large, a value of bₘₐₓᵢₘᵤₘ−b(j) is small. Correspondingly, a value of (bₘₐₓᵢₘᵤₘ−b(j))/s−acc_2T(j) is also small, and a value of tₛₜₒₚ(i) is large. On the contrary, if a value of b(j) is small, a value of tₛₜₒₚ(j) is also small. In other words, if the occupancy of the first buffer is high, the duration for which the second communication apparatus stops data sending is long; or if the occupancy of the first buffer is low, the duration for which the second communication apparatus stops data sending is short. Therefore, according to the transmission control method provided in this disclosure, the second communication apparatus can be dynamically controlled, in real time based on the occupancy of the first buffer, to stop sending or send data.

With reference to the first aspect, in a possible implementation, when j>2, acc_2T (j) satisfies the following second formula:

acc_2T(j)=acc_2T(j−1)−acc[(j−1)% n](j−1)+t−tₛₜₒₚ(j−1),n=2T/t

acc[(j−1)% n](j−1) satisfies the following third formula:

acc[(j−1)% n](j−1)=t−tₛₜₒₚ(j−2)

acc[(j−1)% n](j−1) indicates time for which the second communication apparatus is allowed to send a data packet at a ((j−1)% n)^{th} sampling moment within 2T time before a (j−1)^{th} sampling moment. (j−1)% n indicates a remainder obtained by dividing j−1 by n. When j=1, acc_2T(1)=2T, acc[i](1)=t, and i=0, 1, . . . , n−1; or when j=2, acc_2T (2)=acc_2T(1)−acc[1](1)+t−tₛₜₒₚ(1). tₛₜₒₚ(j−2) indicates first duration determined at a (j−2)^{th} sampling moment. T indicates the unidirectional transmission delay of data transmission between the first communication apparatus and the second communication apparatus. In the transmission control method provided in this disclosure, a value of acc_2T(j) may be iteratively calculated, to prepare for calculation of the first duration.

With reference to the first aspect, in a possible implementation, that the first communication apparatus determines first duration based on the sampling cycle and the occupancy of the first buffer at the first sampling moment includes: when the occupancy of the first buffer at the first sampling moment is greater than a first value, the first communication apparatus determines the first duration based on the sampling cycle and the occupancy of the first buffer at the first sampling moment. The first value is equal to 0 or tends to 0.

With reference to the first aspect, in a possible implementation, that the first communication apparatus determines first duration based on the sampling cycle and the occupancy of the first buffer at the first sampling moment includes: when the occupancy of the first buffer at the first sampling moment is greater than bₘₐₓᵢₘᵤₘ−(2T+t)*s, the first communication apparatus determines the first duration based on the sampling cycle and the occupancy of the first buffer at the first sampling moment. 0≤bₘₐₓᵢₘᵤₘ−(2T+t)*s≤t*s. bₘₐₓᵢₘᵤₘ indicates the size of the first buffer. s indicates the data receiving rate of the port of the first communication apparatus, or s indicates the rate at which the first communication apparatus receives the data packet of the first priority. t indicates the sampling cycle. T indicates the unidirectional transmission delay of data transmission between the first communication apparatus and the second communication apparatus. In the transmission control method provided in this disclosure, the value of the sampling cycle is small, that is, a value of t*s tends to 0, so that a value of bₘₐₓᵢₘᵤₘ−(2T+t)*s is equal to 0 or tends to 0. In other words, a value of bₘₐₓᵢₘᵤₘ may be (2T+t)*s, or a value of bₘₐₓᵢₘᵤₘ may be slightly greater than (2T+t)*s. One BDP defined in another technology is 2T*s, the value of the sampling cycle t is small, and the value of t*s is approximately 0, so that the value of bₘₐₓᵢₘᵤₘ is approximately one BDP. Compared with an existing PFC mechanism that needs buffer space whose size is at least two BDPs, this solution requires only buffer space whose size is approximately one BDP. Therefore, in this solution, a requirement on the size of the buffer space can be reduced. In this way, on the one hand, in a long-distance lossless transmission scenario, the chip including the first communication apparatus has a constant buffer space size, and when buffer space between a transmit port and a receive port of the first communication apparatus is approximately half of that another technology, a quantity of long-distance lossless ports that can be supported by the chip is approximately doubled. On the other hand, the buffer space that is approximately half of that in another technology reduces time for data transmission in the first communication apparatus by half, about 2T, and therefore, a dynamic delay can be reduced, to ensure that service performance is not affected.

With reference to the first aspect, in a possible implementation, that the first communication apparatus sends first indication information to the second communication apparatus includes: when the first duration is greater than 0, the first communication apparatus sends the first indication information to the second communication apparatus. Only when the first duration is greater than 0, the first communication apparatus sends the first indication information to the second communication apparatus, to control the second communication apparatus to stop data packet sending. When the first duration is equal to 0, the duration for which the second communication apparatus stops data sending is very short, so that the second communication apparatus does not need to stop data sending. Therefore, it can be ensured that the receive end continuously receives data packets within a specific error range, and signaling overheads are reduced.

With reference to the first aspect, in a possible implementation, when the first duration is equal to 0, the first communication apparatus sends the second indication information to the second communication apparatus. The second indication information indicates the second communication apparatus to send a data packet.

A second aspect provides a first communication apparatus, configured to implement the foregoing method. The first communication apparatus includes a corresponding module, unit, or means for implementing the foregoing method. The module, unit, or means may be implemented by hardware, by software, or by hardware executing corresponding software. The hardware or the software includes one or more modules or units corresponding to the foregoing functions.

With reference to the second aspect, in a possible implementation, the first communication apparatus includes a transceiver module and a processing module. The processing module is configured to obtain a sampling cycle. The sampling cycle is a time interval at which the first communication apparatus samples occupancy of a first buffer. The first buffer is used to store a data packet of a first priority. The processing module is further configured to determine occupancy of the first buffer at a first sampling moment based on the sampling cycle. The processing module is further configured to determine first duration based on the sampling cycle and the occupancy of the first buffer at the first sampling moment. The first duration is duration for which a second communication apparatus stops sending data to the first communication apparatus. The transceiver module is configured to send first indication information to the second communication apparatus based on the first duration. The first indication information is used to control the duration for which the second communication apparatus stops sending data to the first communication apparatus.

With reference to the second aspect, in a possible implementation, the first duration is less than or equal to the sampling cycle.

With reference to the second aspect, in a possible implementation, the processing module is further configured to: start a timer whose timing duration is the first duration; and when the timer expires, send second indication information to the second communication apparatus by using the transceiver module. The second indication information indicates the second communication apparatus to send a data packet.

With reference to the second aspect, in a possible implementation, the first indication information is the first duration.

With reference to the second aspect, in a possible implementation, the first indication information is second duration. The second duration is maximum duration for which the second communication apparatus is allowed to stop data packet sending.

With reference to the second aspect, in a possible implementation, that the processing module is further configured to determine the first duration based on the sampling cycle and the occupancy of the first buffer at the first sampling moment includes: determining the first duration based on the sampling cycle, the occupancy of the first buffer at the first sampling moment, and at least one of the following parameters: a data receiving rate of a port of the first communication apparatus, a rate at which the first communication apparatus receives the data packet of the first priority, cumulative time for which the second communication apparatus is allowed to send a data packet within 2T time before the first sampling moment, or a size of the first buffer, where T indicates a unidirectional transmission delay of data transmission between the first communication apparatus and the second communication apparatus.

With reference to the second aspect, in a possible implementation, when the first sampling moment is a j^{th} sampling moment, and j is a positive integer, the first duration satisfies the following first formula:

tₛₜₒₚ(j)=t−(bₘₐₓᵢₘᵤₘ−b(j))/s−acc_2T(j))

tₛₜₒₚ(j) indicates first duration determined at the j^{th} sampling moment. t indicates the sampling cycle. bₘₐₓᵢₘᵤₘ indicates the size of the first buffer. s indicates the data receiving rate of the port of the first communication apparatus, or s indicates the rate at which the first communication apparatus receives the data packet of the first priority. b(j) indicates occupancy of the first buffer at the j^{th} sampling moment. acc_2T(j) indicates cumulative time for which the second communication apparatus is allowed to send a data packet within 2T time before the j^{th} sampling moment.

With reference to the second aspect, in a possible implementation, when j>2, acc_2T (j) satisfies the following second formula:

acc_2T(j)=acc_2T(j−1)−acc[(j−1)% n](j−1)+t−tₛₜₒₚ(j−1),n=2T/t

acc[(j−1)% n](j−1) satisfies the following third formula:

acc[(j−1)% n](j−1)=t−tₛₜₒₚ(j−2)

acc[(j−1)% n](j−1) indicates time for which the second communication apparatus is allowed to send a data packet at a ((j−1)% n)^{th} sampling moment within 2T time before a (j−1)^{th} sampling moment. (j−1)% n indicates a remainder obtained by dividing j−1 by n. When j=1, acc_2T(1)=2T, acc[i](1)=t, and i=0, 1, . . . , n−1; or when j=2, acc_2T (2)=acc_2T(1)−acc[1](1)+t−tₛₜₒₚ(1). tₛₜₒₚ(j−2) indicates first duration determined at a (j−2)^{th} sampling moment. T indicates the unidirectional transmission delay of data transmission between the first communication apparatus and the second communication apparatus.

With reference to the second aspect, in a possible implementation, that the processing module is further configured to determine the first duration based on the sampling cycle and the occupancy of the first buffer at the first sampling moment includes: when the occupancy of the first buffer at the first sampling moment is greater than a first value, determining the first duration based on the sampling cycle and the occupancy of the first buffer at the first sampling moment. The first value is equal to 0 or tends to 0.

With reference to the second aspect, in a possible implementation, that the processing module is further configured to determine the first duration based on the sampling cycle and the occupancy of the first buffer at the first sampling moment includes: when the occupancy of the first buffer at the first sampling moment is greater than bₘₐₓᵢₘᵤₘ−(2T+t)*s, determining the first duration based on the sampling cycle and the occupancy of the first buffer at the first sampling moment. A value of bₘₐₓᵢₘᵤₘ−(2T+t)*s is equal to 0 or tends to 0. bₘₐₓᵢₘᵤₘ indicates the size of the first buffer. s indicates the data receiving rate of the first communication apparatus, or S indicates the rate at which the first communication apparatus receives the data packet of the first priority. t indicates the sampling cycle. T indicates the unidirectional transmission delay of data transmission between the first communication apparatus and the second communication apparatus.

With reference to the second aspect, in a possible implementation, that the transceiver module is configured to send the first indication information to the second communication apparatus includes: when the first duration is greater than 0, sending the first indication information to the second communication apparatus.

With reference to the second aspect, in a possible implementation, the transceiver module is further configured to: when the first duration is equal to 0, send the second indication information to the second communication apparatus. The second indication information indicates the second communication apparatus to send a data packet.

With reference to the second aspect, in a possible implementation, the processing module may be a processor, and the transceiver module may be a communication module connected through a communication interface.

For technical effects brought by any possible implementation of the second aspect, refer to technical effects brought by the first aspect or different implementations of the first aspect. Details are not described herein again.

A third aspect provides a first communication apparatus, including a processor. The processor is configured to: be coupled to a memory, and after reading computer instructions stored in the memory, perform the method in the first aspect based on the instructions.

With reference to the third aspect, in a possible implementation, the communication apparatus further includes the memory. The memory is configured to store the computer instructions.

With reference to the third aspect, in a possible implementation, the communication apparatus further includes a communication interface. The communication interface is configured for the communication apparatus to communicate with another device. For example, the communication interface may be a transceiver, an input/output interface, an interface circuit, an output circuit, an input circuit, a pin, or a related circuit.

With reference to the third aspect, in a possible implementation, the communication apparatus may be a chip or a chip system. When the communication apparatus is a chip system, the communication apparatus may include a chip, or may include a chip and another discrete device.

With reference to the third aspect, in a possible implementation, when the communication apparatus is a chip or a chip system, the communication interface may be an input/output interface, an interface circuit, an output circuit, an input circuit, a pin, a related circuit, or the like on the chip or the chip system. The processor may also be embodied as a processing circuit or a logic circuit.

A fourth aspect provides a computer-readable storage medium. The computer-readable storage medium stores instructions. When the instructions are run on a computer, the computer is enabled to perform the method in the first aspect.

A fifth aspect provides a communication system, including a second communication apparatus and a first communication apparatus that performs the method in the first aspect.

A sixth aspect provides a computer program product including instructions. When the computer program product is run on a computer, the computer is enabled to perform the method in the first aspect.

For technical effects brought by any possible implementation of the third aspect to the sixth aspect, refer to technical effects brought by the first aspect or different implementations of the first aspect. Details are not described herein again.

### BRIEF DESCRIPTION OF DRAWINGS

FIG. 1 is a schematic diagram of a PFC-protocol-based control process.

FIG. 2 is a schematic diagram of a working principle of PFC.

FIG. 3 is a schematic diagram of a structure of a PFC frame.

FIG. 4 is a curve chart of a size of space occupied by a data packet at a receive end when a size of buffer space of the receive end is two BDPs.

FIG. 5 is a curve chart of a size of space occupied by a data packet at a receive end when a size of buffer space of the receive end is less than two BDPs.

FIG. 6 is a schematic diagram of an architecture of a communication system according to an embodiment of this disclosure.

FIG. 7 is a schematic diagram of a network architecture of an active-active DC.

FIG. 8 is a schematic diagram of a structure of a communication apparatus according to an embodiment of this disclosure.

FIG. 9 is a flowchart 1 of a transmission control method according to an embodiment of this disclosure.

FIG. 10 is a flowchart 2 of a transmission control method according to an embodiment of this disclosure.

FIG. 11 is a flowchart 3 of a transmission control method according to an embodiment of this disclosure.

FIG. 12 is a flowchart 4 of a transmission control method according to an embodiment of this disclosure.

FIG. 13 is a schematic diagram of a structure of a communication apparatus according to an embodiment of this disclosure.

### DESCRIPTION OF EMBODIMENTS

For ease of understanding the technical solutions in embodiments of this disclosure, the following first briefly describes technologies or terms related to this disclosure.

It should be noted that in the following embodiments, an example in which a parameter s indicates a data receiving rate of a first communication apparatus is used for description. Unified descriptions are provided herein, and details are not described below again.

First: PFC Protocol

When data is transmitted between data centers, the PFC protocol may be used to reduce packet loss in the Ethernet.

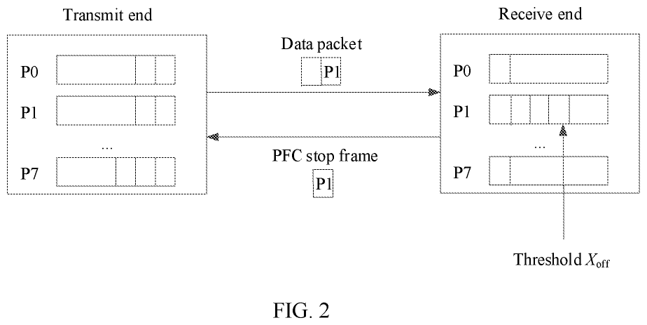

FIG. 2 shows a working principle of PFC. At a transmit end or a receive end, a data packet of a priority P0, P1, . . . , P6, or P7 is stored in buffer space allocated to the priority. A data packet of the priority P1 is used as an example. The receive end continuously receives data packets of the priority P1 from the transmit end, and stores the data packets in buffer space allocated to the priority P1. When a data packet processing capability of the receive end is inadequate, a rate at which the receive end receives the data packets of the priority P1 is greater than a rate at which the receive end outputs the data packets of the priority P1, and consequently, the data packets of the priority P1 are overstocked. When space occupied by a data packet of the priority P1 accumulates to a threshold X_{off}, the receive end sends a PFC stop frame to the transmit end, to request the transmit end to stop sending a data packet of the priority P1.

Second: PFC Frame

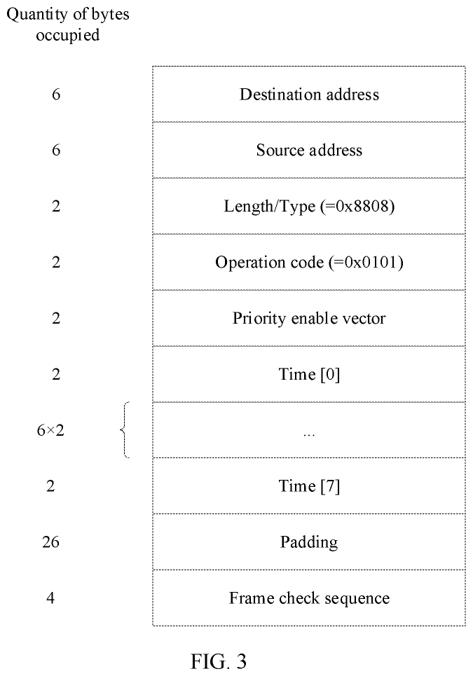

FIG. 3 shows a schematic diagram of a structure of the PFC frame, including a “destination address”, a “source address”, a “length/type (=0x8808)”, an “operation code (=0x0101)”, a “priority enable vector”, time fields (“time [0]”, “time [1]”, . . . , “time [7]”), a “padding”, and a “frame check sequence”. The “destination address” and the “source address” each occupy six bytes. The “length/type”, the “operation code”, and the “priority enable vector” each occupy two bytes. Each of the time fields occupies two bytes. The “padding” occupies 26 bytes. The “frame check sequence” occupies four bytes.

In the PFC frame, the time field is used to carry time for which the transmit end stops sending a data packet of a corresponding priority. A count in each time field ranges from 0 to 65535. One count value indicates time required for transmission of 512 bits. The field “time [0]” is used as an example. If a rate of receiving and sending data between the transmit end and the receive end is 100 Gbps, and a count value in the field “time [0]” in the PFC stop frame sent by the receive end to the transmit end is 65535, time for which the transmit end needs to stop sending a data packet of the priority P0 is 65535*512 b/100 Gbps=335.5392 microseconds (s).

Particularly, when a count value in a specific time field is 0, it indicates that time for which the transmit end stops sending a data packet of a corresponding priority is 0, in other words, the transmit end is allowed to send the data packet of the corresponding priority. In this case, the PFC frame is a PFC transmit frame.

In the PFC frame, the “priority enable vector” is used to determine whether to enable each time field. The “priority enable vector” may be represented as e[7] . . . e[1]e[0]. For example, when e[i]=1, it may indicate that a field “time [i]” is enabled; or when e[i]=0, it may indicate that a field “time [i]” is disabled. i=0, 1, . . . 7.

For definitions and function descriptions of the other fields in the PFC frame, refer to related standard documents. Details are not described herein again.

Third: HDRM

With reference to FIG. 2, after the receive end sends the PFC stop frame to the transmit end, the transmit end does not immediately stop data packet sending, so that the receive end still continues to receive data packets of the priority P1 from the transmit end until a last data packet sent by the transmit end before stopping data packet sending arrives at the receive end. Therefore, the HDRM is defined in the PFC protocol. The HDRM is used to store data packets received by the receive end between a moment at which the receive end sends the PFC stop frame and a moment at which the receive end receives the last data packet.

A size of the HDRM is one BDP. One BDP satisfies the following formula (1):

BDP=s*2T Formula (1)

s indicates the rate of receiving and sending data between the transmit end and the receive end. T indicates a unidirectional transmission delay of data transmission between the transmit end and the receive end, including an internal delay and an external line transmission delay. Especially in a long-distance transmission scenario, the external line transmission delay accounts for a large proportion, and the internal delay accounts for a small proportion. For definitions and calculation methods of the internal delay and the external line transmission delay, refer to the IEEE802.1Qbb standard document. Details are not described herein again.

Fourth: Size of Buffer Space of the Receive End

In an existing PFC protocol, in addition to that the HDRM occupies buffer space of one BDP, X_{off}, and Xₒₙ also need a buffer whose size is at least one BDP, to ensure that the receive end continuously outputs data packets. That is, in an existing PFC mechanism, the receive end needs buffer space whose size is at least two BDPs. Correspondingly, time T_{D} for data transmission at the receive end satisfies the following formula (2):

T_{D}=2BDP/s=2*s*2T/s=4T Formula (2)

For meanings of parameters in Formula (2), refer to corresponding parameters in Formula (1). Details are not described herein again.

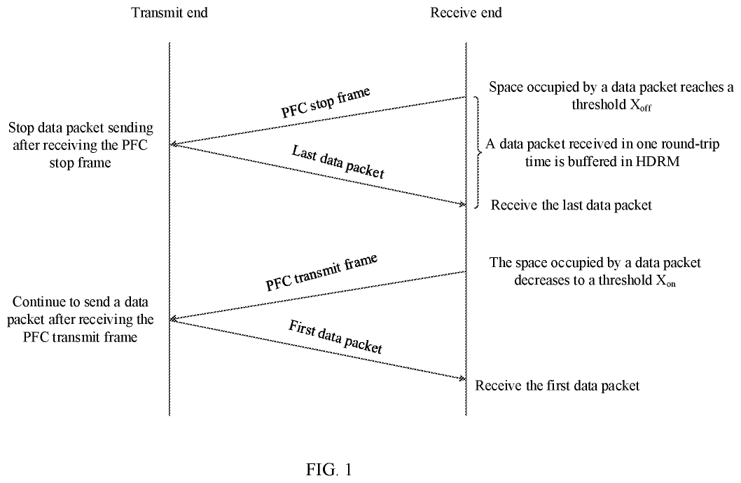

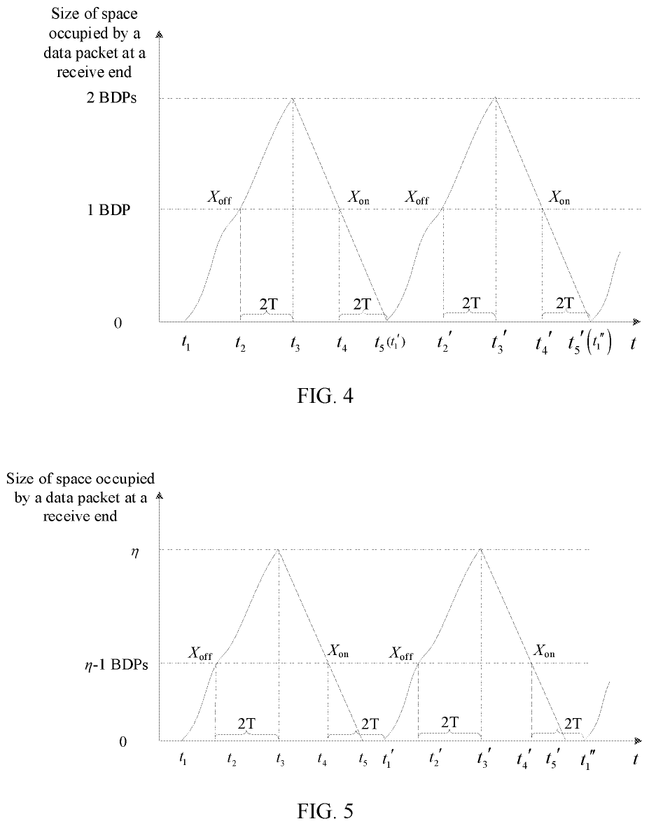

FIG. 4 shows a curve of a size of space occupied by a data packet at the receive end when the size of the buffer space of the receive end is two BDPs. The following describes a control cycle from t₁ to t₅ in FIG. 4 with reference to a schematic diagram of a PFC-protocol-based control process shown in FIG. 1.

In FIG. 4, the moment t₁ is a moment at which the size of the space occupied by a data packet at the receive end is 0. A moment t₂ is a moment at which the space occupied by a data packet at the receive end reaches the threshold X_{off}. A value of X_{off} is one BDP. In this case, the receive end sends the PFC stop frame to the transmit end. In a time period from t₁ to t₂, the data packet processing capability of the receive end is inadequate, and consequently, data packets at the receive end are overstocked. Therefore, the space occupied by a data packet at the receive end gradually increases.

The moment t₂ to a moment t₃ are used to transmit the PFC stop frame and the last data packet sent by the transmit end before stopping data packet sending, and the duration is one round-trip time, that is, 2T. In a time period from t₂ to t₃, a data packet received by the receive end is buffered in the HDRM, and the HDRM occupies buffer space of one BDP. Therefore, the space occupied by a data packet at the receive end increases by one BDP. The moment t₃ is a moment at which the space occupied by a data packet at the receive end reaches a maximum value. The maximum value is the size of the buffer space of the receive end, that is, two BDPs. In this case, the receive end receives the last data packet sent by the transmit end before stopping data packet sending.

In a time period from t₃ to t₄, the receive end no longer receives but only outputs a data packet, so that the space occupied by a data packet at the receive end gradually decreases. Therefore, overstocking of data packets at the receive end starts to be alleviated. It is assumed herein that a rate at which the receive end outputs a data packet and a rate at which the receive end receives a data packet are the same, that is, both s. In other words, in the time period from t₃ to t₄, a rate at which the space occupied by a data packet at the receive end decreases is s. The moment t₄ is a moment at which the space occupied by a data packet at the receive end decreases to a threshold Xₒₙ. In this case, the receive end starts to send the PFC transmit frame to the transmit end. A value of Xₒₙ is less than or equal to that of X_{off}. It is assumed herein that the value of Xₒₙ is equal to that of X_{off}, and is one BDP.

The moment t₄ to the moment t₅ are used to transmit the PFC transmit frame and a first data packet sent by the transmit end after resuming sending, and duration is one round-trip time, that is, 2T. In a time period from t₄ to t₅, the receive end is still in a state in which no data packet is input but output, so that the space occupied by a data packet at the receive end still decreases at the rate s. If the space occupied by a data packet at the receive end decreases at the rate s for 2T, a decrease is s*2T. That is, the decrease is one BDP. It is clear that the moment t₅ is a moment at which the size of the space occupied by a data packet at the receive end is 0 again, and the moment t₅ is also a moment t₁′ in a next control cycle. In this case, the receive end receives the first data packet sent by the transmit end.

In another technology, the values of X_{off} and Xₒₙ are usually reduced, to reduce a requirement on the size of the buffer space of the receive end. However, when X_{off} is less than one BDP, that is, when the size of the buffer space of the receive end is less than two BDPs, a problem that the receive end has no data packet to output is introduced.

FIG. 5 shows a curve of a size of space occupied by a data packet at the receive end when the size of the buffer space of the receive end is less than two BDPs. If the size of the buffer space of the receive end is η, and η is less than two BDPs, a buffer size required by X_{off} and Xₒₙ is obtained by subtracting one BDP from η, and a difference is less than one BDP.

With reference to FIG. 4, in FIG. 5, the moment t₅ is a moment at which the size of the space occupied by a data packet at the receive end is 0 again. In the time period from t₄ to t₅, the space occupied by a data packet at the receive end still decreases at the rate s. However, a decrease from Xₒₙ to 0 is less than one BDP, so that decrease duration is less than 2T. Therefore, between the moment t₅ and the start moment t₁′ of the next control period, there is a period of time in which the space occupied by a data packet at the receive end remains 0. That is, the receive end has no data packet to output in a time period from t₅ to t₁′. The moment t₁′ is a moment at which the receive end receives the first data packet sent by the transmit end.

The following describes the technical solutions in embodiments of this disclosure with reference to the accompanying drawings in embodiments of this disclosure. In the descriptions of this disclosure, unless otherwise specified, “/” indicates that associated objects are in an “or” relationship. For example, A/B may indicate A or B. In this disclosure, “and/or” is merely an association relationship describing associated objects, and indicates that three relationships may exist. For example, A and/or B may indicate the following three cases: only A exists, both A and B exist, and only B exists. A and B each may be singular or plural. In addition, in descriptions of this disclosure, unless otherwise specified, “a plurality of” means two or more than two. “At least one of the following items (pieces)” or a similar expression thereof means any combination of these items, including a single item (piece) or any combination of a plurality of items (pieces). For example, at least one of a, b, or c may indicate: a, b, c, a and b, a and c, b and c, or a, b, and c, where a, b, and c may be singular or plural. In addition, to clearly describe the technical solutions in embodiments of this disclosure, words such as “first” and “second” are used in embodiments of this disclosure to distinguish between same items or similar items that have basically a same function and effect. A person skilled in the art may understand that the words such as “first” and “second” do not limit a quantity and an execution order, and the words “first” and “second” are not necessarily different. In addition, in embodiments of this disclosure, terms such as “example” or “for example” are used to represent giving an example, an illustration, or a description. Any embodiment or design solution described as “an example” or “for example” in embodiments of this disclosure should not be construed to be more preferential or advantageous than other embodiments or design solutions. To be precise, the terms such as “example” or “for example” are intended to present a related concept in a specific manner for ease of understanding.

In addition, an application scenario described in embodiments of this disclosure is intended to more clearly describe the technical solutions in embodiments of this disclosure, and does not constitute a limitation on the technical solutions provided in embodiments of this disclosure. A person of ordinary skill in the art may know that with emergence of a new scenario, the technical solutions provided in embodiments of this disclosure are also applicable to a similar technical problem.

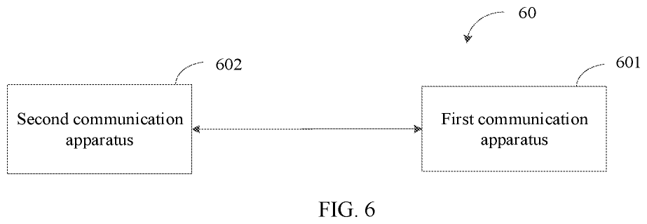

FIG. 6 shows a communication system 60 according to an embodiment of this disclosure. The communication system 60 includes a first communication apparatus 601 and a second communication apparatus 602 that communicate with each other.

The first communication apparatus 601 is configured to obtain a sampling cycle. The sampling cycle is a time interval at which the first communication apparatus 601 samples occupancy of a first buffer. The first buffer is used to store a data packet of a first priority. The first communication apparatus 601 is further configured to determine occupancy of the first buffer at a first sampling moment based on the sampling cycle. The first communication apparatus 601 is further configured to determine first duration based on the sampling cycle and the occupancy of the first buffer at the first sampling moment. The first duration is duration for which the second communication apparatus 602 stops sending data to the first communication apparatus 601. The first communication apparatus 601 is further configured to send first indication information to the second communication apparatus 602 based on the first duration. The first indication information is used to control the duration for which the second communication apparatus 602 stops sending data to the first communication apparatus 601. The second communication apparatus 602 is configured to receive the first indication information from the first communication apparatus 601. Specific implementation and technical effects of this solution are described in detail in subsequent method embodiments, and details are not described herein again.

The following uses an active-active data center (DC) as an example to describe the application scenario according to embodiments of this disclosure. “Active-active” indicates that both an active device and a standby device exist.

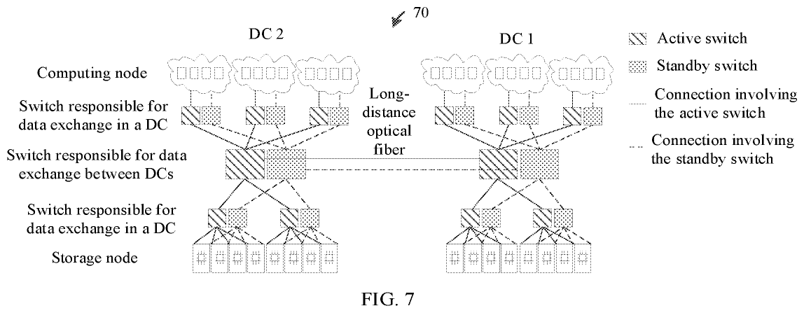

FIG. 7 shows a communication system including a DC 1 and a DC 2. Each DC includes a computing node for data computing, a switch responsible for data exchange in the DC, a switch responsible for data exchange between DCs, and a storage node for data storage. As shown in FIG. 7, the switches are classified into active switches and standby switches. Communication is performed between active switches of different DCs and between standby switches of different DCs through a long-distance optical fiber, to implement long-distance lossless transmission. For example, as shown in FIG. 7, an active switch responsible for data exchange between DCs in the DC 1 performs data transmission with an active switch responsible for data exchange between DCs in the DC 2 through a long-distance optical fiber, and a standby switch responsible for data exchange between DCs in the DC 1 performs data transmission with a standby switch responsible for data exchange between DCs in the DC 2 through the long-distance optical fiber.

For example, the first communication apparatus 601 in FIG. 6 may be the active switch responsible for data exchange between DCs in the DC 1 in FIG. 7, and the second communication apparatus 602 in FIG. 6 may be the active switch responsible for data exchange between DCs in the DC 2 in FIG. 7. Alternatively, the first communication apparatus 601 in FIG. 6 may be the standby switch responsible for data exchange between DCs in the DC 1 in FIG. 7, and the second communication apparatus 602 in FIG. 6 may be the standby switch responsible for data exchange between DCs in the DC 2 in FIG. 7.

Optionally, a related function of the first communication apparatus or the second communication apparatus in this embodiment of this disclosure may be implemented by one device, may be jointly implemented by a plurality of devices, or may be implemented by one or more functional modules in one device. This is not limited in this embodiment of this disclosure. It may be understood that the foregoing function may be a network element in a hardware device, a software function run on dedicated hardware, a combination of hardware and software, or a virtualization function instantiated on a platform (for example, a cloud platform).

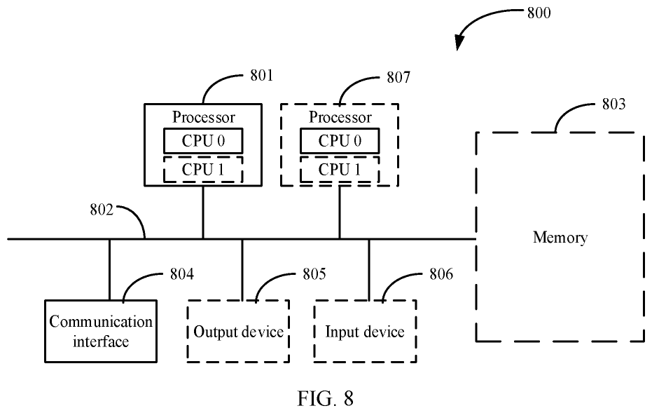

For example, the related function of the first communication apparatus or the second communication apparatus in this embodiment of this disclosure may be implemented by using a communication apparatus 800 in FIG. 8.

FIG. 8 is a schematic diagram of a structure of a communication apparatus 800 according to an embodiment of this disclosure. The communication apparatus 800 includes one or more processors 801, a communication line 802, and at least one communication interface (in FIG. 8, only an example in which a communication interface 804 and one processor 801 are included is used for description). Optionally, the communication apparatus 800 may further include a memory 803.

The processor 801 may be a central processing unit (CPU), a microprocessor, an application-specific integrated circuit (ASIC), or one or more integrated circuits configured to control program execution in the solution of this disclosure.

The communication line 802 may include a path for connecting different components.

The communication interface 804 may be a transceiver module configured to communicate with another device or a communication network, for example, the Ethernet, a radio access network (RAN), or a wireless local area network (WLAN). For example, the transceiver module may be an apparatus such as a transceiver or a transceiver machine. Optionally, the communication interface 804 may alternatively be a transceiver circuit located in the processor 801, to implement signal input and signal output of the processor.

The memory 803 may be an apparatus with a storage function, for example, may be but is not limited to a read-only memory (ROM) or another type of static storage device capable of storing static information and instructions, a random-access memory (RAM) or another type of dynamic storage device capable of storing information and instructions, an electrically erasable programmable read-only memory (EEPROM), or a compact disc read-only memory (CD-ROM) or another optical disk storage, optical disc storage (including a compressed optical disc, a laser disc, an optical disc, a digital versatile disc (DVD), a BLUE-RAY disc, and the like), a magnetic disk storage medium or another magnetic storage device, or any other medium capable of carrying or storing desired program code in a form of an instruction or a data structure and accessible by a computer. The memory may exist independently, and is connected to the processor through the communication line 802. Alternatively, the memory may be integrated with the processor.

The memory 803 is configured to store computer-executable instructions for performing the solutions of this disclosure, and the processor 801 controls execution. The processor 801 is configured to execute the computer-executable instructions stored in the memory 803, to implement a transmission control method provided in embodiments of this disclosure.

Alternatively, in this embodiment of this disclosure, the processor 801 may perform a processing-related function in a transmission control method provided in the following embodiment of this disclosure, and the communication interface 804 is responsible for communication with the other device or the communication network. This is not limited in this embodiment of this disclosure.

The computer-executable instruction in this embodiment of this disclosure may also be referred to as application program code. This is not limited in this embodiment of this disclosure.

In specific implementation, in an embodiment, the processor 801 may include one or more CPUs, for example, a CPU 0 and a CPU 1 in FIG. 8.

In specific implementation, in an embodiment, the communication apparatus 800 may include a plurality of processors, for example, the processor 801 and a processor 807 in FIG. 8. Each of these processors may be a single-core (single-CPU) processor or a multi-core (multi-CPU) processor. The processor herein may be one or more devices, circuits, and/or processing cores configured to process data (for example, computer program instructions).

In specific implementation, in an embodiment, the communication apparatus 800 may further include an output device 805 and an input device 806. The output device 805 communicates with the processor 801, and may display information in a plurality of manners.

The communication apparatus 800 may be a general-purpose apparatus or a dedicated apparatus. For example, the communication apparatus 800 may be a desktop computer, a portable computer, a network server, a personal digital assistant (PDA), a mobile phone, a tablet computer, a wireless terminal apparatus, an in-vehicle terminal apparatus, an embedded device, or a device of a structure similar to that in FIG. 8. A type of the communication apparatus 800 is not limited in this embodiment of this disclosure.

The following describes in detail the transmission control method provided in embodiments of this disclosure with reference to FIG. 1 to FIG. 8.

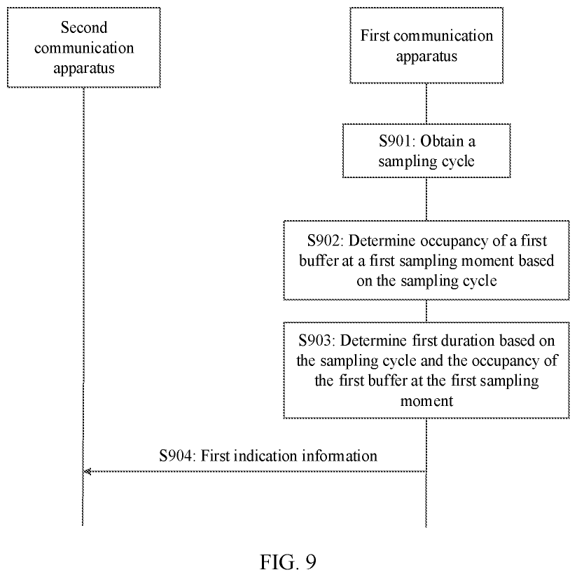

FIG. 9 shows the transmission control method according to an embodiment of this disclosure. The transmission control method includes the following steps.

S901: A first communication apparatus obtains a sampling cycle. The sampling cycle is a time interval at which the first communication apparatus samples occupancy of a first buffer. The first buffer is used to store a data packet of a first priority.

In this embodiment of this disclosure, HDRM is preconfigured for the data packet of the first priority, and a size of the HDRM is one BDP. A value of the BDP may be manually calculated with reference to the IEEE802.1Qbb standard, or a value of the BDP may be obtained by using an automatic measurement method. This is not limited in this disclosure. Optionally, the first communication apparatus may further obtain a data receiving rate S of the first communication apparatus, and calculate, based on a value of S and the determined value of the BDP, a unidirectional transmission delay T of data transmission between the first communication apparatus and the second communication apparatus. For example, T=BDP/(2*s).

Optionally, in this embodiment of this disclosure, first buffer space whose size is bₘₐₓᵢₘᵤₘ may be further preconfigured. This is not limited in this embodiment of this disclosure.

S902: The first communication apparatus determines occupancy of the first buffer at a first sampling moment based on the sampling cycle.

S903: The first communication apparatus determines first duration based on the sampling cycle and the occupancy of the first buffer at the first sampling moment. The first duration is duration for which a second communication apparatus stops sending data to the first communication apparatus.

In a possible implementation, the first duration is less than or equal to the sampling cycle. The second communication apparatus is allowed to send the data packet of the first priority to the first communication apparatus in a first sampling cycle other than the first duration. Therefore, compared with an existing technical solution in which the first communication apparatus allows the second communication apparatus to send the data packet of the first priority only when the occupancy of the first buffer decreases to a threshold Xₒₙ, in the transmission control method provided in this disclosure, the second communication apparatus may be allowed in advance to send the data packet of the first priority, to ensure that a receive end continuously outputs data packets.

In a possible implementation, when the occupancy of the first buffer at the first sampling moment is greater than bₘₐₓᵢₘᵤₘ−(2T+t)*s, the first communication apparatus determines the first duration based on the sampling cycle and the occupancy of the first buffer at the first sampling moment. A value of bₘₐₓᵢₘᵤₘ−(2T+t)*s is equal to 0 or tends to 0. bₘₐₓᵢₘᵤₘ indicates the size of the first buffer. S indicates the data receiving rate of the first communication apparatus. t indicates the sampling cycle. T indicates the unidirectional transmission delay of data transmission between the first communication apparatus and the second communication apparatus.

In the transmission control method provided in this disclosure, the value of bₘₐₓᵢₘᵤₘ−(2T+t)*s is equal to 0 or tends to 0. In other words, a value of bₘₐₓᵢₘᵤₘ may be (2T+t)*s, or a value of bₘₐₓᵢₘᵤₘ may be slightly greater than (2T+t)*s. One BDP defined in another technology is 2T*s, a value of the sampling cycle t is small, and a value of t*S is approximately 0, so that the value of bₘₐₓᵢₘᵤₘ is approximately one BDP. Compared with an existing PFC mechanism that needs buffer space whose size is at least two BDPs, this solution requires only buffer space whose size is approximately one BDP. Therefore, in this solution, a requirement on the size of the buffer space can be reduced. In this way, on the one hand, in a long-distance lossless transmission scenario, a chip including the first communication apparatus has a constant buffer space size, and when buffer space between a transmit port and a receive port of the first communication apparatus is approximately half of that in another technology, a quantity of long-distance lossless ports that can be supported by the chip is approximately doubled. On the other hand, the buffer space that is approximately half of that in another technology reduces time for data transmission in the first communication apparatus by half, about 2T, and therefore, a dynamic delay can be reduced, to ensure that service performance is not affected.

Optionally, in this embodiment of this disclosure, when the first sampling moment is a j^{th} sampling moment, and j is a positive integer, the first duration satisfies the following formula (3):

tₛₜₒₚ(j)=t−((bₘₐₓᵢₘᵤₘ−b(j))/s−acc_2T(j)) Formula (3)

tₛₜₒₚ(j) indicates first duration determined at the j^{th} sampling moment. t indicates the sampling cycle. bₘₐₓᵢₘᵤₘ indicates the size of the first buffer. s indicates the data receiving rate of the first communication apparatus. b(j) indicates occupancy of the first buffer at the j^{th} sampling moment. acc_2T (j) indicates cumulative time for which the second communication apparatus is allowed to send a data packet within 2T time before the j^{th} sampling moment.

In this embodiment of this disclosure, the first communication apparatus periodically calculates, based on the occupancy of the first buffer, the first duration for which the second communication apparatus stops data sending. At the j^{th} sampling moment, if a value of b(j) is large, a value of bₘₐₓᵢₘᵤₘ−b(j) is small. Correspondingly, a value of (bₘₐₓᵢₘᵤₘ−b(j))/s−acc_2T (j) is also small, and a value of tₛₜₒₚ(j) is large. On the contrary, if a value of b(j) is small, a value of tₛₜₒₚ(j) is also small. In other words, if the occupancy of the first buffer is low, the duration for which the second communication apparatus stops data sending is long; or if the occupancy of the first buffer is low, the duration for which the second communication apparatus stops data sending is short. Therefore, according to the transmission control method provided in this disclosure, the second communication apparatus can be dynamically controlled, in real time based on the occupancy of the first buffer, to stop sending or send data.

Refer to Formula (3). In the formula for calculating the first duration, t, bₘₐₓᵢₘᵤₘ, and s are constant values, and b(j) indicates the occupancy of the first buffer sampled at the j^{th} sampling moment. Therefore, a value of acc_2T(j) needs to be calculated, to calculate tₛₜₒₚ(j).

Optionally, in this embodiment of this disclosure, the value of acc_2T(j) may be iteratively calculated. In a possible implementation, when j>2, acc_2T(j) satisfies the following formula (4):

acc_2T(j)=acc_2T(j−1)−acc[(j−1)% n](j−1)+t−tₛₜₒₚ(j−1),n=2T/t Formula (4)

acc[(j−1)% n](j−1) satisfies the following formula (5):

acc[(j−1)% n](j−1)=t−tₛₜₒₚ(j−2) Formula(5)

acc_2T(j−1) indicates cumulative time for which the second communication apparatus is allowed to send a data packet within 2T time before a (j−1)^{th} sampling moment. acc[(j−1)% n](j−1) indicates time for which the second communication apparatus is allowed to send a data packet at a ((j−1)% n)^{th} sampling moment within 2T time before the (j−1)^{th} sampling moment. (j−1)% n indicates a remainder obtained by dividing j−1 by n. t indicates the sampling cycle. When j=1, acc_2T(1)=2T, acc[i](1)=t, and i=0, 1, . . . , n−1; or when j=2, acc 2T(2)=acc_2T(1)−acc[1](1)+t−ₛₜₒₚ(1). tₛₜₒₚ(j−1) indicates first duration determined at the (j−1) sampling moment. tₛₜₒₚ(j−2) indicates first duration determined at a (j−2)^{th} sampling moment.

The following provides an example in which acc_2T(j) is iteratively calculated.

For example, when n=2T/t=1000 μs/10 μs=100,

for a 101^{st} sampling moment, that is, when j=101, acc_2T(101) satisfies the following formula (6):

acc_2T(101)=acc_2T(100)−acc[0](100)+t−tₛₜₒₚ(100) Formula (6)

acc_2T(100) and tₛₜₒₚ(100) are both calculated at a 100^{th} sampling moment. acc[0](100) satisfies the following formula (7):

acc[0](100)=t−tₛₜₒₚ(99) Formula (7)

tₛₜₒₚ(99) is calculated at a 99^{th} sampling moment.

For a 102^{nd} sampling moment, that is, when j=102, acc_2T(102) satisfies the following formula (8):

acc_2T(102)=acc_2T(101)−acc[1](101)+t−tₛₜₒₚ(101) Formula (8)

acc_2T(101) and tₛₜₒₚ(101) are both calculated at the 101^{st} sampling moment. acc[1](101) satisfies the following formula (9):

acc[1](101)=t−tₛₜₒₚ(100) Formula (9)

tₛₜₒₚ(100) is calculated at the 100^{th} sampling moment.

For a 103^{rd} sampling moment, that is, when j=103, acc_2T(103) satisfies the following formula (10):

acc_2T(103)=acc_2T(102)−acc[2](102)+t−tₛₜₒₚ(102) Formula (10)

acc_2T(102) and tₛₜₒₚ(102) are both calculated at the 102^{nd} sampling moment. acc[2](102) satisfies the following formula (11):

acc[2](102)=t−tₛₜₒₚ(101) Formula (11)

tₛₜₒₚ(101) is calculated at the 101^{st} sampling moment.

S904: The first communication apparatus sends first indication information to the second communication apparatus based on the first duration. Correspondingly, the second communication apparatus receives the first indication information from the first communication apparatus. The first indication information is used to control the duration for which the second communication apparatus stops sending data to the first communication apparatus.

For example, the first indication information may be carried in a PFC stop frame. The PFC stop frame is a PFC frame in which a count value in a time field corresponding to the first priority is not 0.

Optionally, that the first communication apparatus sends first indication information to the second communication apparatus includes: when the first duration is greater than 0, the first communication apparatus sends first indication information 0 to the second communication apparatus. In this solution, only when the first duration is greater than 0, the first communication apparatus sends the first indication information to the second communication apparatus, to control the second communication apparatus to stop data packet sending. When the first duration is equal to 0, the second communication apparatus does not need to stop data sending.

Optionally, the transmission control method provided in this embodiment of this disclosure may further include: the first communication apparatus starts a timer whose timing duration is the first duration. When the timer expires, the first communication apparatus sends second indication information to the second communication apparatus. The second indication information indicates the second communication apparatus to send a data packet. In this solution, a moment at which the second communication apparatus sends a data packet to the first communication apparatus is controlled by using a timing function of the first communication apparatus, so that when the second communication apparatus does not have the timing function, the second communication apparatus can send the data packet to the first communication apparatus in time.

In a possible implementation, in this embodiment of this disclosure, the first indication information is the first duration. In other words, the second communication apparatus may continue to send data after stopping data sending for the first duration based on the first indication information. In this solution, after the first communication apparatus sends the first indication information to the second communication apparatus, the second communication apparatus may not need to be triggered again, through signaling transmission, to resume data packet sending, so that signaling overheads can be reduced.

It should be noted that the duration in this embodiment of this disclosure may be a length of a time period, for example, 5.12 μs. Alternatively, the duration in this embodiment of this disclosure may be a count value corresponding to a length of a time period. For example, for a PFC frame, duration may be a count value that corresponds to 5.12 μs and that is in the time field corresponding to the first priority. If a rate of receiving and sending data between the transmit end and the receive end is 100 Gbps, the count value corresponding to 5.12 μs is 5.12 μs*100 Gbps/512 b=1074.

In another possible implementation, in this embodiment of this disclosure, when the first communication apparatus starts the timer whose timing duration is the first duration, the first indication information is second duration. The second duration is maximum duration for which the second communication apparatus is allowed to stop data packet sending. In this solution, the first indication information is a time field in the PFC stop frame sent by the receive end to the transmit end in another technology if the space occupied by a data packet at the receive end reaches the threshold X_{off}. Content of communication between the first communication apparatus and the second communication apparatus is the same as that in another technology, so that compatibility with an existing protocol may be improved.

For example, if the first indication information is carried in the PFC stop frame, the second duration may be a maximum count value, that is, 65535.

Optionally, the transmission control method provided in this embodiment of this disclosure may further include: when the first duration is equal to 0, the first communication apparatus sends the second indication information to the second communication apparatus. The second indication information indicates the second communication apparatus to send a data packet. The duration for which the second communication apparatus stops data sending is very short, so that the second communication apparatus is allowed to send data, to ensure continuity of receiving data packets by the receive end within a specific error range.

For example, the second indication information may be carried in a PFC transmit frame. The PFC transmit frame is a PFC frame in which a count value in a time field corresponding to the first priority is 0.

In the transmission control method provided in this disclosure, the first communication apparatus periodically samples the occupancy of the first buffer, and determines the first duration based on the sampling cycle and the sampled occupancy of the first buffer. The value of the sampling cycle is small, so that based on this solution, the second communication apparatus can be controlled, at a finer granularity, to stop sending or send the data packet of the first priority.

Both the first communication apparatus and the second communication apparatus in the foregoing embodiment may use the architecture of the communication apparatus 800 shown in FIG. 8. Therefore, actions of the first communication apparatus in the foregoing embodiment may be performed by the first communication apparatus indicated by the processor 801 in the communication apparatus 800 shown in FIG. 8 by invoking the application program code stored in the memory 803, and actions of the second communication apparatus in the foregoing embodiment may be performed by the second communication apparatus indicated by the processor 801 in the communication apparatus 800 shown in FIG. 8 by invoking the application program code stored in the memory 803. This is not limited in this embodiment.

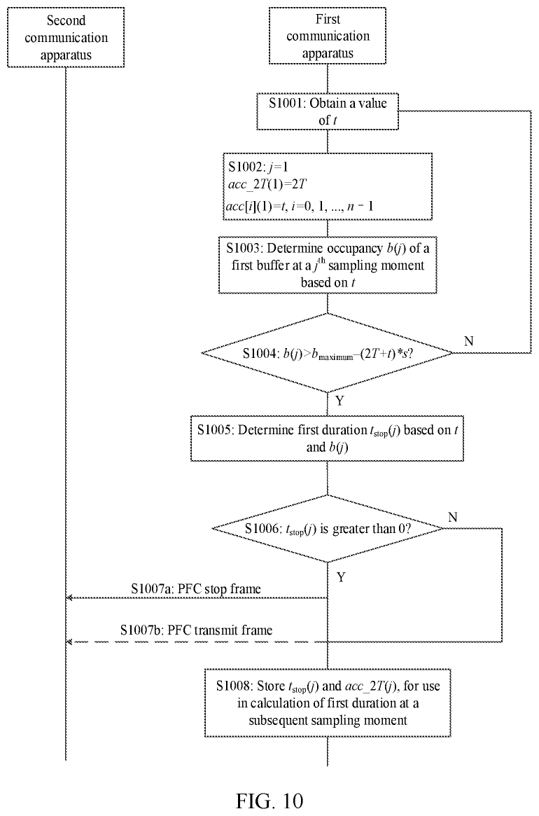

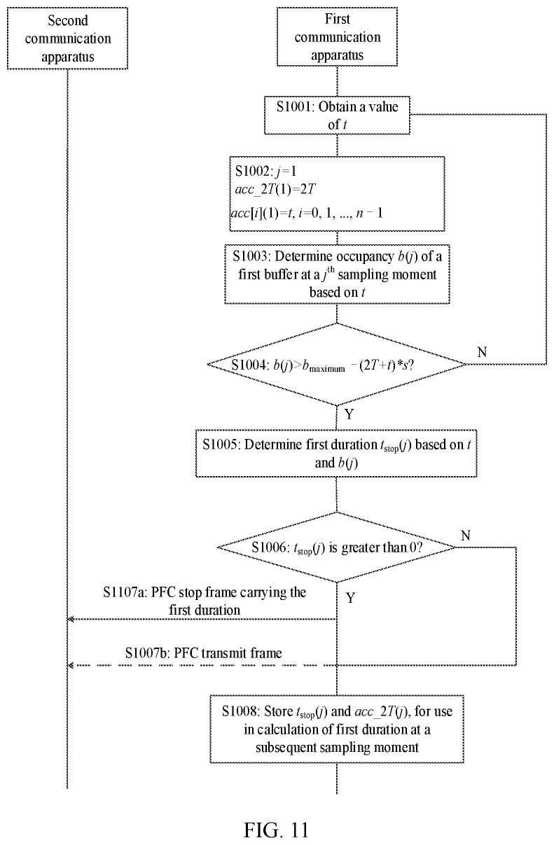

With reference to FIG. 4, in FIG. 5, the moment e to the transmission control method in FIG. 9, FIG. 10 shows a specific example of the transmission control method provided in this disclosure. An example in which the first sampling moment is the j^{th} sampling moment is used. The example includes the following steps.

S1001: The first communication apparatus obtains the sampling cycle t.

For related descriptions of step S1001, refer to step S901 in the embodiment shown in FIG. 9. Details are not described herein again.

S1002: The first communication apparatus may set an initial value of j to 1. The first communication apparatus may set an initial value acc_2T(1) of acc_2T to 2T, and set an initial value acc[i](1) of acc[i] to t.

S1003: The first communication apparatus determines the occupancy b(j) of the first buffer at the j^{th} sampling moment based on the sampling cycle t.

S1004: The first communication apparatus determines whether b(j) is greater than bₘₐₓᵢₘᵤₘ−(2T+t)*s. The value of bₘₐₓᵢₘᵤₘ−(2T+t)*s is equal to 0 or tends to 0.

If b(j) is greater than bₘₐₓᵢₘᵤₘ−(2T+t)*s, the first communication apparatus performs the following step S1005; or if b(j) is less than or equal to bₘₐₓᵢₘᵤₘ−(2T+t)*s, the first communication apparatus performs the foregoing step S1001 or S1002.

S1005: The first communication apparatus determines the first duration tₛₜₒₚ(j) based on the sampling cycle t and the occupancy b(j) of the first buffer at the first sampling moment. The first duration tₛₜₒₚ(j) is duration for which the second communication apparatus stops sending data to the first communication apparatus. The first duration tₛₜₒₚ(j) is less than or equal to the sampling cycle.

In this embodiment of this disclosure, for a process of determining the first duration tₛₜₒₚ(j), refer to related descriptions of step S903. Details are not described herein again.

S1006: The first communication apparatus determines whether b(j) is greater than 0.

If b(j) is greater than 0, the following step S1007a is performed.

If b(j) is equal to 0, the following step S1007b is performed, or the first communication apparatus skips step S1007b, and directly performs step S1008.

S1007a: The first communication apparatus sends the first indication information to the second communication apparatus based on the first duration. Correspondingly, the second communication apparatus receives the first indication information from the first communication apparatus. The first indication information is used to control the duration for which the second communication apparatus stops sending data to the first communication apparatus.

For example, as shown in FIG. 10, the first indication information may be carried in the PFC stop frame. The first indication information may be the first duration, and correspondingly, the count value in the time field that is of the PFC stop frame and that corresponds to the first priority is the first duration. Alternatively, the first indication information is the second duration, and correspondingly, the count value in the time field that is of the PFC stop frame and that corresponds to the first priority is the second duration. This is not limited in this disclosure.

S1007b: The first communication apparatus sends the second indication information to the second communication apparatus. Correspondingly, the second communication apparatus receives the second indication information from the first communication apparatus. The second indication information indicates the second communication apparatus to send a data packet.

For example, as shown in FIG. 10, the first indication information may be carried in the PFC transmit frame.

S1008: The first communication apparatus stores the first duration tₛₜₒₚ(i) and acc_2T(j) that are calculated this time, for use in calculation of first duration at a subsequent sampling moment.

For technical effects of the transmission control method provided in the embodiment shown in FIG. 10, refer to the descriptions of the technical effects of the embodiment shown in FIG. 9. Details are not described herein again.

With reference to FIG. 10, FIG. 11 shows an example in which the first indication information is the first duration. This example may be used in a case in which the second communication apparatus has the timing function. A difference between the example shown in FIG. 11 and the example shown in FIG. 10 lies in the following step.

S1107a: The first communication apparatus sends the first indication information to the second communication apparatus. Correspondingly, the second communication apparatus receives the first indication information from the first communication apparatus. The first indication information is used to control the duration for which the second communication apparatus stops sending data to the first communication apparatus. The first indication information is the first duration.

For example, as shown in FIG. 11, the first indication information may be carried in the PFC stop frame. The count value in the time field that is of the PFC stop frame and that corresponds to the first priority is the first duration.

It should be noted that in this embodiment of this disclosure, the first duration may be the first duration tₛₜₒₚ(j) determined in step S1005, or may be a count value corresponding to tₛₜₒₚ(j).

With reference to the foregoing example, when the second communication apparatus has the timing function, the first communication apparatus may directly send the first duration to the second communication apparatus. After stopping data sending for the first duration, the second communication apparatus can automatically resume data packet sending, so that the second communication apparatus does not need to be triggered again, through signaling transmission, to resume data packet sending. Therefore, signaling can be reduced.

For technical effects of the transmission control method provided in the embodiment shown in FIG. 11, refer to the descriptions of the technical effects of the embodiment shown in FIG. 9. Details are not described herein again.

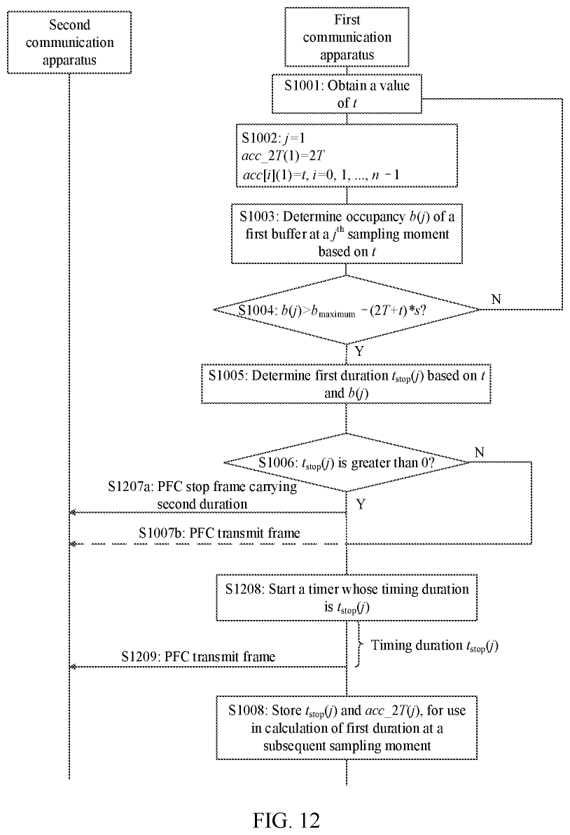

With reference to FIG. 10, FIG. 12 shows an example in which the first indication information is the second duration. This example may be used in a case in which the second communication apparatus does not have the timing function. A difference between the example shown in FIG. 12 and the example shown in FIG. 10 lies in the following steps.

S1207a: The first communication apparatus sends the first indication information to the second communication apparatus. Correspondingly, the second communication apparatus receives the first indication information from the first communication apparatus. The first indication information is used to control the duration for which the second communication apparatus stops sending data to the first communication apparatus. The first indication information is the second duration.

For example, as shown in FIG. 12, the first indication information may be carried in the PFC stop frame. The count value in the time field that is of the PFC stop frame and that corresponds to the first priority is 65535. In other words, the second duration is the maximum count value, that is, 65535.

S1208: The first communication apparatus starts the timer whose timing duration is the first duration tₛₜₒₚ(j).

When the timer expires, the following step S1209 is performed.

S1209: The first communication apparatus sends the second indication information to the second communication apparatus. Correspondingly, the second communication apparatus receives the second indication information from the first communication apparatus. The second indication information indicates the second communication apparatus to send a data packet.

For example, as shown in FIG. 12, the second indication information may be carried in the PFC transmit frame.

For technical effects of the transmission control method provided in the embodiment shown in FIG. 12, refer to the descriptions of the technical effects of the embodiment shown in FIG. 9. Details are not described herein again.

It may be understood that in the foregoing embodiments, the method and/or steps implemented by the first communication apparatus may also be implemented by a part (for example, a chip or a circuit) that may be used in the first communication apparatus. The method and/or steps implemented by the second communication apparatus may also be implemented by a part (for example, a chip or a circuit) that may be used in the second communication apparatus.

The foregoing mainly describes the solutions provided in embodiments of this disclosure from the perspective of interaction between network elements. Correspondingly, an embodiment of this disclosure further provides a communication apparatus. The communication apparatus is configured to implement the foregoing methods. The communication apparatus may be the first communication apparatus in the foregoing method embodiment, an apparatus including the foregoing first communication apparatus, or a part that may be used in the first communication apparatus. Alternatively, the communication apparatus may be the second communication apparatus in the foregoing method embodiment, an apparatus including the foregoing second communication apparatus, or a part that may be used in the second communication apparatus. It may be understood that the communication apparatus includes a corresponding hardware structure and/or software module that performs each function, to implement the foregoing functions. A person skilled in the art should be easily aware that units and algorithm steps in the examples described with reference to embodiments disclosed in this specification may be implemented in a form of hardware or in a form of a combination of hardware and computer software in this disclosure. Whether a function is performed by hardware or by hardware driven by computer software depends on particular applications and design constraints of the technical solutions. A person skilled in the art may use different methods to implement the described functions for each particular application, but it should not be considered that the implementation goes beyond the scope of this disclosure.

In embodiments of this disclosure, the communication apparatus may be divided into functional modules based on the foregoing method embodiment. For example, each functional module may be obtained through division based on each corresponding function, or two or more functions may be integrated into one processing module. The integrated module may be implemented in a form of hardware, or may be implemented in a form of a software functional module. It is to be noted that in embodiments of this disclosure, module division is an example, and is merely a logical function division. During actual implementation, another division manner may be used.

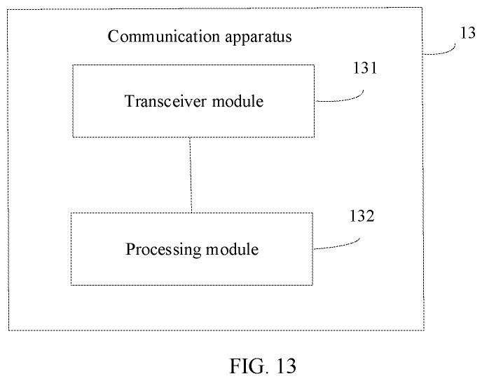

FIG. 13 is a schematic diagram of a structure of a communication apparatus 13. The communication apparatus 13 includes a transceiver module 131 and a processing module 132. The transceiver module 131 may also be referred to as a transceiver unit, and is configured to implement a transceiver function. For example, the transceiver module may be a transceiver circuit, a transceiver machine, a transceiver, or a communication interface.

For example, the communication apparatus 13 is the first communication apparatus in the foregoing method embodiment. In this case: the processing module 132 is configured to obtain a sampling cycle. The sampling cycle is a time interval at which the first communication apparatus samples occupancy of a first buffer. The first buffer is used to store a data packet of a first priority. The processing module 132 is further configured to determine occupancy of the first buffer at a first sampling moment based on the sampling cycle. The processing module 132 is further configured to determine first duration based on the sampling cycle and the occupancy of the first buffer at the first sampling moment. The first duration is duration for which a second communication apparatus stops sending data to the first communication apparatus. The transceiver module 131 is configured to send first indication information to the second communication apparatus based on the first duration. The first indication information is used to control the duration for which the second communication apparatus stops sending data to the first communication apparatus.

In a possible implementation, the processing module 132 is further configured to: start a timer whose timing duration is the first duration; and when the timer expires, send second indication information to the second communication apparatus by using the transceiver module 131. The second indication information indicates the second communication apparatus to send a data packet.

In a possible implementation, that the processing module 132 is further configured to determine the first duration based on the sampling cycle and the occupancy of the first buffer at the first sampling moment includes: when the occupancy of the first buffer at the first sampling moment is greater than bₘₐₓᵢₘᵤₘ−(2T+t)*s, determining the first duration based on the sampling cycle and the occupancy of the first buffer at the first sampling moment. A value of bₘₐₓᵢₘᵤₘ−(2T+t)*s is equal to 0 or tends to 0. bₘₐₓᵢₘᵤₘ indicates a size of the first buffer. S indicates a data receiving rate of the first communication apparatus. t indicates the sampling cycle. T indicates a unidirectional transmission delay of data transmission between the first communication apparatus and the second communication apparatus.

In a possible implementation, that the transceiver module 131 is configured to send the first indication information to the second communication apparatus includes: when the first duration is greater than 0, sending the first indication information to the second communication apparatus.

In a possible implementation, the transceiver module 131 is further configured to: when the first duration is equal to 0, send the second indication information to the second communication apparatus. The second indication information indicates the second communication apparatus to send a data packet.

All related content of each step in the foregoing method embodiment may be cited in function descriptions of a corresponding functional module. Details are not described herein again.

In this embodiment, the communication apparatus 13 is presented in a form of functional modules obtained through integration. The “module” herein may be a specific ASIC, a circuit, a processor that executes one or more software or firmware programs, a memory, an integrated logic circuit, and/or another device capable of providing the foregoing functions.

When the communication apparatus 13 is the first communication apparatus or the second communication apparatus in the foregoing method embodiment, in a simple embodiment, a person skilled in the art may figure out that the communication apparatus 13 may be in a form of the communication apparatus 800 shown in FIG. 8.

For example, the processor 801 or 807 in the communication apparatus 800 shown in FIG. 8 may invoke the computer-executable instructions stored in the memory 803, so that the communication apparatus 800 performs the transmission control method in the foregoing method embodiment. A function/implementation process of the processing module 132 in FIG. 13 may be implemented by the processor 801 or 807 in the communication apparatus 800 shown in FIG. 8 by invoking the computer-executable instructions stored in the memory 803. A function/implementation process of the transceiver module 131 in FIG. 13 may be implemented by using the communication module connected through the communication interface 804 in FIG. 8.

The communication apparatus 13 provided in this embodiment may perform the foregoing transmission control method. Therefore, for technical effects that can be achieved by the communication apparatus 13, refer to the foregoing method embodiment. Details are not described herein again.

It should be noted that one or more of the foregoing modules or units may be implemented by software, hardware, or a combination thereof. When any one of the foregoing modules or units is implemented by software, the software exists in a form of a computer program instruction, and is stored in a memory. A processor may be configured to execute the program instruction and implement the foregoing method procedures. The processor may be built into a system-on-a-chip (SoC) or an ASIC, or may be an independent semiconductor chip. In addition to cores configured to execute software instructions to perform operations or processing, the processor may further include a necessary hardware accelerator, for example, a field-programmable gate array (FPGA), a programmable logic device (PLD), or a logic circuit implementing a dedicated logical operation.

When the foregoing modules or units are implemented by hardware, the hardware may be any one or any combination of a CPU, a microprocessor, a digital signal processing (DSP) chip, a microcontroller unit (MCU), an artificial intelligence processor, an ASIC, a SoC, an FPGA, a PLD, a dedicated digital circuit, a hardware accelerator, or a non-integrated discrete device. The hardware may perform the foregoing method procedures by running necessary software or independently of software.

Optionally, an embodiment of this disclosure further provides a chip system, including at least one processor and an interface. The at least one processor is coupled to a memory through the interface. When the at least one processor executes a computer program or instructions in the memory, the method according to any one of the foregoing method embodiments is performed. In a possible implementation, the communication apparatus further includes the memory. Optionally, the chip system may include a chip, or may include a chip and another discrete device. This is not limited in this embodiment of this disclosure.

All or some of the foregoing embodiments may be implemented by software, hardware, firmware, or any combination thereof. When implemented by a software program, all or some of the foregoing embodiments may be implemented in a form of a computer program product. The computer program product includes one or more computer instructions. When the computer program instructions are loaded and executed on a computer, all or some of the procedures or functions according to embodiments of this disclosure are generated. The computer may be a general-purpose computer, a dedicated computer, a computer network, or another programmable apparatus. The computer instructions may be stored in a computer-readable storage medium, or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by the computer, or a data storage device, for example, a server or a data center, integrating one or more usable media. The usable medium may be a magnetic medium (for example, a floppy disk, a hard disk, or a magnetic tape), an optical medium (for example, a DVD), a semiconductor medium (for example, a solid-state disk (SSD)), or the like.

Although this disclosure is described with reference to embodiments, in a process of implementing this disclosure that claims protection, a person skilled in the art may understand and implement another variation of the disclosed embodiments by viewing the accompanying drawings, the disclosed content, and the appended claims. In the claims, “comprising” does not exclude another component or another step, and “a” or “one” does not exclude a case of plurality. A single processor or another unit may implement several functions enumerated in the claims. Some measures are set forth in dependent claims that are different from each other, but this does not mean that these measures cannot be combined to achieve good effects.

Although this disclosure is described with reference to specific features and embodiments thereof, it is clear that various modifications and combinations may be made to them without departing from the spirit and scope of this disclosure. Correspondingly, the specification and the accompanying drawings are merely example descriptions of this disclosure defined by the accompanying claims, and are considered as any of or all modifications, variations, combinations, or equivalents that cover the scope of this disclosure. It is clear that a person skilled in the art may make various modifications and variations to this disclosure without departing from the spirit and scope of this disclosure. This disclosure is intended to cover these modifications and variations of this disclosure provided that they fall within the scope of protection defined by the following claims and their equivalent technologies.

What is claimed is:

1. A method, comprising:
obtaining a sampling cycle, wherein the sampling cycle is a time interval at which a first communication apparatus samples a first occupancy of a first buffer, and wherein the first buffer stores a first data packet of a first priority;
obtaining, based on the sampling cycle, a second occupancy of the first buffer at a first sampling moment;
obtaining, based on the sampling cycle and the second occupancy, a first duration for a second communication apparatus to stop sending data to the first communication apparatus; and
sending, based on the first duration and to the second communication apparatus, first indication information,
wherein the first indication information is configured to control the first duration.

2. The method of claim 1, wherein the first duration is less than or equal to the sampling cycle.

3. The method of claim 1, further comprising:
starting a timer, wherein a timing duration of the timer is the first duration; and
sending, when the timer expires and to the second communication apparatus, second indication information,
wherein the second indication information instructs the second communication apparatus to send a second data packet.

4. The method of claim 3, wherein the first indication information comprises a second duration, and wherein the second duration is a maximum duration for the second communication apparatus to stop sending the data.

5. The method of claim 1, wherein the first indication information comprises the first duration.

6. The method of claim 1, wherein obtaining the first duration comprises obtaining, further based on at least one of a data receiving rate of a port of the first communication apparatus, a rate at which the first communication apparatus receives the first data packet, a cumulative time for which the second communication apparatus is allowed to send a second data packet within 2T time before the first sampling moment, or a size of the first buffer, the first duration, and wherein T indicates a unidirectional transmission delay of data transmission between the first communication apparatus and the second communication apparatus.

7. The method of claim 1, wherein when the first sampling moment is a j^{th} sampling moment and j is a positive integer, the first duration satisfies the following first formula:
tₛₜₒₚ(j)=t−((bₘₐₓᵢₘᵤₘ−b(j))/s−acc_2T(j)),
wherein tₛₜₒₚ(j) indicates the first duration obtained at the j^{th} sampling moment, wherein t indicates the sampling cycle, wherein bₘₐₓᵢₘᵤₘ indicates a size of the first buffer, wherein S indicates a first data receiving rate of a port of the first communication apparatus or s indicates a second rate at which the first communication apparatus receives the first data packet, wherein b(j) indicates a third occupancy of the first buffer at the j^{th} sampling moment, and wherein acc_2T(j) indicates a cumulative time for the second communication apparatus to send a second data packet within 2T time before the j^{th} sampling moment.

8. The method of claim 7, wherein when j>2, acc_2T(j) satisfies the following second formula:
acc_2T(j)=acc_2T(j−1)−acc[(j−1)% n](j−1)+t−tₛₜₒₚ(j−1),n=2T/t,
wherein acc[(j−1)% n](j−1) satisfies the following third formula:
acc[(j−1)% n](j−1)=t−tₛₜₒₚ(j−2),
wherein acc[(j−1)% n](j−1) indicates a time for the second communication apparatus to send a third data packet at a ((j−1)% n)^{th} sampling moment within 2T time before a (j−1)^{th} sampling moment, wherein (j−1)% n indicates a remainder obtained by dividing j−1 by n, wherein when j=1, acc_2T(1)=2T, acc[i](1)=t, and i=0, 1 . . . , n−1, wherein when j=2, acc_2T(2)=acc_2T(1)−acc[1](1)+t−tₛₜₒₚ(1), wherein tₛₜₒₚ(j−2) indicates a second duration obtained at a (j−2)^{th} sampling moment, and wherein T indicates a unidirectional transmission delay of data transmission between the first communication apparatus and the second communication apparatus.

9. The method of claim 1, wherein obtaining the first duration comprises obtaining the first duration when the second occupancy is greater than bₘₐₓᵢₘᵤₘ−(2T+t)*s, wherein 0≤bₘₐₓᵢₘᵤₘ−(2T+t)*s≤t*s, wherein bₘₐₓᵢₘᵤₘ indicates a size of the first buffer, wherein S indicates a data receiving rate of a port of the first communication apparatus, or s indicates a rate at which the first communication apparatus receives the first data packet, wherein t indicates the sampling cycle, and wherein T indicates a unidirectional transmission delay of data transmission between the first communication apparatus and the second communication apparatus.

10. The method of claim 1, wherein sending the first indication information comprises sending the first indication information when the first duration is greater than 0.

11. The method of claim 10, further comprising sending, to the second communication apparatus, second indication information when the first duration is equal to 0, wherein the second indication information instructs the second communication apparatus to send a second data packet.

12. An apparatus, comprising:
a memory configured to store instructions; and
one or more processors coupled to the memory and configured to execute the instructions to:
obtain a sampling cycle, wherein the sampling cycle is a time interval at which the apparatus samples a first occupancy of a first buffer, and wherein the first buffer stores a first data packet of a first priority;
obtain, based on the sampling cycle, a second occupancy of the first buffer at a first sampling moment;
obtain, based on the sampling cycle and the second occupancy, a first duration for a second communication apparatus to stop sending data to the apparatus; and
send, based on the first duration and to the second communication apparatus, first indication information,
wherein the first indication information is configured to control the first duration.

13. The apparatus of claim 12, wherein the first duration is less than or equal to the sampling cycle.

14. The apparatus of claim 12, wherein the one or more processors are further configured to:
start a timer, wherein a timing duration of the timer is the first duration; and
send, when the timer expires and to the second communication apparatus, second indication information,
wherein the second indication information instructs the second communication apparatus to send a second data packet.

15. The apparatus of claim 14, wherein the first indication information comprises a second duration, and wherein the second duration is a maximum duration for the second communication apparatus to stop sending the data.

16. The apparatus of claim 12, wherein the first indication information comprises the first duration.

17. The apparatus of claim 12, wherein the one or more processors are further configured to obtain, based on at least one of a data receiving rate of a port of the apparatus, a rate at which the apparatus receives the first data packet, or a cumulative time for which the second communication apparatus is allowed to send a second data packet within 2T time before the first sampling moment, or a size of the first buffer, and wherein T indicates a unidirectional transmission delay of data transmission between the apparatus and the second communication apparatus.

18. The apparatus of claim 12, wherein when the first sampling moment is a j^{th} sampling moment, and j is a positive integer, the first duration satisfies the following first formula:
tₛₜₒₚ(j)=t−((bₘₐₓᵢₘᵤₘ−b(j))/s−acc_2T(j)),
wherein tₛₜₒₚ(j) indicates the first duration obtained at the j^{th} sampling moment, wherein t indicates the sampling cycle, wherein bₘₐₓᵢₘᵤₘ indicates a size of the first buffer, wherein S indicates a first data receiving rate of a port of the apparatus, or s indicates a second rate at which the apparatus receives the first data packet, wherein b(j) indicates a third occupancy of the first buffer at the j^{th} sampling moment, and wherein acc_2T(j) indicates a cumulative time for the second communication apparatus to send a second data packet within 2T time before the j^{th} sampling moment.

19. The apparatus of claim 18, wherein when j>2, acc_2T(j) satisfies the following second formula:
acc_2T(j)=acc_2T(j−1)−acc[(j−1)% n](j−1)+t−tₛₜₒₚ(j−1),n=2T/t,
wherein acc[(j−1)% n](j−1) satisfies the following third formula:
acc[(j−1)% n](j−1)=t−tₛₜₒₚ(j−2),
wherein acc[(j−1)% n](j−1) indicates a time for the second communication apparatus to send a third data packet at a ((j−1)% n)^{th} sampling moment within 2T time before a (j−1)^{th} sampling moment, wherein (j−1)% n indicates a remainder obtained by dividing j−1 by n, wherein when j=1, acc_2T(1)=2T, acc[i](1)=t, and i=0, 1, . . . , n−1, wherein when j=2, acc_2T (2)=acc_2T(1)−acc[1](1)+t−tₛₜₒₚ(1), wherein tₛₜₒₚ(j−2) indicates a second duration obtained at a (j−2)^{th} sampling moment, and wherein T indicates a unidirectional transmission delay of data transmission between the apparatus and the second communication apparatus.

20. A computer program product comprising instructions stored on a non-transitory computer-readable medium that, when executed by one or more processors, cause an apparatus to:
obtain a sampling cycle, wherein the sampling cycle is a time interval at which a first communication apparatus samples a first occupancy of a first buffer, and wherein the first buffer stores a first data packet of a first priority;
obtain, based on the sampling cycle, a second occupancy of the first buffer at a first sampling moment;
obtain, based on the sampling cycle and the second occupancy, a first duration for a second communication apparatus to stop sending data to the first communication apparatus; and
send, based on the first duration and to the second communication apparatus, first indication information,
wherein the first indication information is configured to control the first duration.
